(19) United States
(12) Patent Application Publication
(10) Pub. No.: US 2018/0330378 A1
(43) Pub. Date: Nov. 15, 2018

(54) FRAUDULENT PAYMENT DETECTION SYSTEM

(71) Applicant: GOOGLE INC., Mountain View, CA (US)

(72) Inventors: Dan Fredinburg, San Francisco, CA (US); Andrew Cary Swerdlow, San Francisco, CA (US)

(73) Assignee: GOOGLE INC., Mountain View, CA (US)

(21) Appl. No.: 13/673,867

(22) Filed: Nov. 9, 2012

(51) Int. Cl. G06Q 20/40

(52) U.S. Cl. CPC G06Q 20/4016

(57) ABSTRACT

A computer-implemented method for detecting a fraudulent payment transaction, including steps for receiving user location information, receiving user payment history information and building a predictive model, for a user, based on the user location information and the user payment history information. In certain aspects, the method further includes steps for receiving user status information in addition to a transaction event and evaluating the transaction event using the user status information and the predictive model to determine a likelihood that the transaction event is fraudulent. Systems and computer-readable media are also provided.

### BACKGROUND

The disclosed subject matter provides a method for detecting the dissemination of private user information and, in particular, provides methods for detecting potentially fraudulent payment transactions, such as credit card transactions.

Some fraud detection technologies are limited by the availability of user or customer information that can be used to identify fraudulent payment activity. For example, some fraud detection technologies rely solely on patterns in a user's payment history, such as credit card transactions history, to determine if a particular charge is authorized or fraudulent. Because of limitations in the types of available user information, conventional fraud detection technologies often fail to detect fraudulent charges and/or produce false positives for non-fraudulent transaction events.

### SUMMARY

The disclosed subject matter relates to a computer-implemented method for detecting a fraudulent payment transaction, the method including receiving, using one or more computing devices, user location information, receiving, using one or more computing devices, user payment history information, building, using one or more computing devices, a predictive model, for a user, based on the user location information and the user payment history information and receiving, using one or more computing devices, user status information in addition to a transaction event. In certain aspects, the method may further include evaluating the transaction event, using one or more computing devices, based on the user status information and the predictive model to determine a likelihood that the transaction event is fraudulent.

The disclosed subject matter also relates to a system for detecting a fraudulent payment transaction, the system comprising, one or more processors and a computer-readable medium comprising instructions stored therein, which when executed by the processors, cause the processors to perform operations comprising, receiving demographic information for a user, receiving user location information, receiving user payment history information and building a predictive model, for a user, based on the demographic information, the user location information and the user payment history information. In certain aspects, the operations may further include receiving user status information in addition to a transaction event and evaluating the transaction event using the user status information and the predictive model to determine a likelihood that the transaction event is fraudulent.

The disclosed subject matter also relates to a non-transitory computer-readable storage medium comprising instructions stored therein, which when executed by a processor, cause the processor to perform operations comprising, receiving demographic information for a user, receiving user location information, receiving user payment history information, building a predictive model, for a user, based on the demographic information, the user location information and the user payment history information and receiving user status information in addition to a transaction event. In certain aspects, the operations further include evaluating the transaction event using the user status information and the predictive model to determine a likelihood that the transaction event is fraudulent.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative, and not restrictive in nature.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1A illustrates a block diagram of an example system for building a predictive model, according to some aspects of the subject disclosure.

FIG. 1B illustrates a block diagram of an example system for implementing a predictive model, according to some aspects of the disclosure.

FIG. 2 illustrates an example method, for implementing some aspects of the subject technology.

FIG. 3 illustrates an example network system that can be used to implement some aspects of the subject technology.

FIG. 4 illustrates an example of an electronic system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these specific details. In some instances, structures and components are shown in block diagram form in order to avoid obscuring the concepts of the subject technology.

I. Overview

The subject technology provides a means for detecting the availability of sensitive or personal user information and for detecting the fraudulent use of such information. In certain aspects, the subject technology comprises a method for building a predictive model based on various types of user/customer information. In certain aspects, the predictive model can be based on user location information and/or information indicating the public availability of sensitive or personal user information, such as sensitive financial information (e.g., credit card or bank account numbers) and/or personal identification information.

By way of example, a predictive user model can be constructed (and updated) based on historic and new/recent user information. Although the predictive model may incorporate various types of information for a particular user (or group of users), in certain aspects, the predictive model can include user location information indicating the most recent and/or historic physical locations of a user. For example, user location information may include information indicating the physical location of the user, such as, IP geo-location information inferred from the user's present or past online activity.

The predictive model may also be based on an index search response that indicates the availability/unavailability of personal or sensitive user information on a publicly available computer database or network, such as the Internet. Personal user information may include a variety of personal or sensitive data about one or more users, such as sensitive financial information (e.g., credit card or bank account numbers) and/or personal identification information. By building a predictive model based on user location information and evaluating transaction events using an index search response, the user's commercial transactions can be evaluated to determine the likelihood of fraudulent activity.

Transaction events determined to be at a high risk for fraud can be flagged and provided to the user via one or more online communication channels. For example, fraud alerts may be provided via email, text message alerts or information provided directly into an online stream or social media feed, etc.

II. Example Systems for Building a Predictive Model

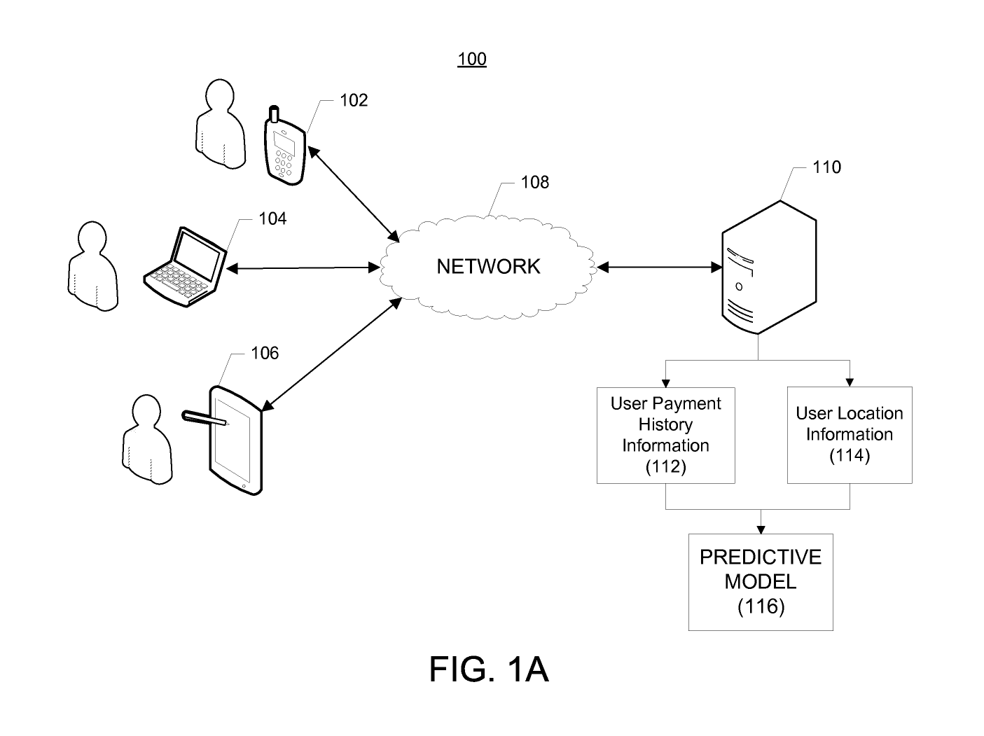

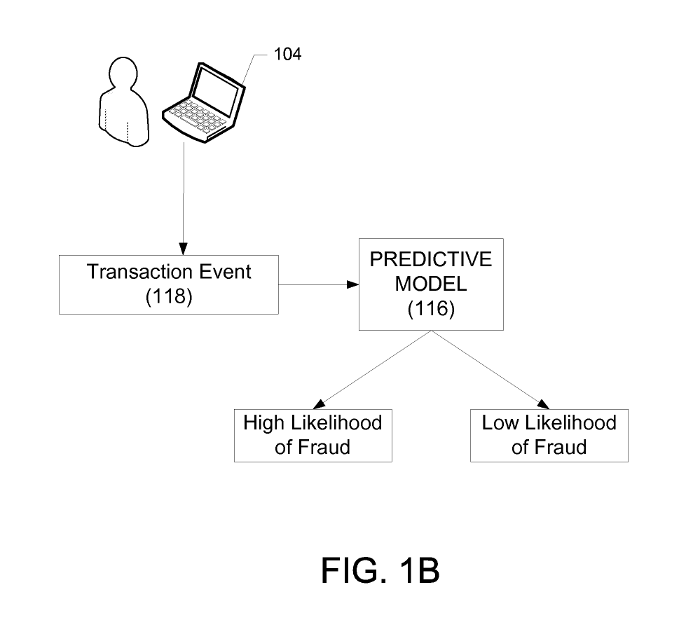

FIG. 1A illustrates a block diagram of an example system 100 for building a predictive model. System 100 includes first, second and third user devices (102, 104 and 106), network 108 and server 110. As illustrated, first, second and third user devices (102, 104 and 106) are coupled to server 110, via network 108.

System 100 can be used to build and/or update predictive model 116. As used herein “predictive model” refers to a model that can be used to predict the likelihood that a given payment transaction is fraudulent. Although predictive model 116 can be used for multiple users, in some aspects, predictive model 116 will be specific to a particular user. As such, each of multiple users, for example, users associated with first, second and third user devices (102, 104 and 106).

Various types of information can be used to build and update predictive model 116. In certain implementations, predictive model 116 will be based, at least in part, on user payment history information 112 and user location information 114. As used herein, “user payment information” can refer to various information or data related to purchases made by one or more users. For example, user payment information can include credit card or bank transaction information for purchases made by a particular user, including payment recipient information, payment amounts and/or transaction location, etc. User payment information can also include data regarding transactions for multiple users.

As used herein, “user location information” can refer to any information or data that can be used to identify the location of a user or a group of users. User location information 114 can comprise a variety of information indicating the physical location of a particular user, for example, geo-positioning system (GPS) data and/or location information inferred from transactions made at physical retail locations, etc.

In some implementations, user payment history information 112 and user location information 114, can be received by remote server 110 from first, second and third user devices (102, 104 and 106) associated with different users. Subsequently, received payment history information 112 and user location information 114 can be used to build predictive model 116 for one or more users, such as those associated with first, second and third user devices (102, 104 and 106).

FIG. 1B illustrates a block diagram of an example system for implementing predictive model 116 for a user associated with second user device 104. By way of example, predictive model 116 can be based on payment history information 112 and user location information 114 for the user associated with second user device 104. Subsequently, each payment transaction made by the user can be evaluated by predictive model 116, for example, to determine the likelihood that the payment transaction is fraudulent.

In certain implementations, after being presented with a payment transaction, predictive model 116 will return a numeric result indicating the determined likelihood of fraudulent payment activity. This result will then be compared to a threshold to determine whether or not the transaction is suspicion and the user should be alerted. In some implementations, payment transactions that have a low likelihood of being fraudulent (e.g., those significantly less than the threshold) will be completed without providing any notification to the user. Furthermore, non-suspect payment transactions may be used to update predictive model 116, for example, using a machine-learning technique.

Any type of information may be used to update predictive model 116, or may be used by predictive model 116 for evaluating a particular transaction. In some implementations, an index search response indicating the availability of personal information for a user may be used by predictive model 116 to determine the likelihood that a particular transaction is fraudulent.

By way of example, a transaction for a user associated with second user device 104 may be evaluated by predictive model 116, concurrently with an index search response indicating that personal information for the user is not available on the public network (e.g., the Internet). Accordingly, the determined likelihood that the transaction is fraudulent may be relatively low, and no notice will be provided to the user.

In contrast, the same transaction event may be evaluated by predictive model 116, with an index search response indicating that personal information for the user is available, for example, via one or more publicly accessible online resources. Accordingly, the likelihood that the transaction event is fraudulent may be determined to be relatively high, and the user will be notified of the suspect transaction.

III. Example Processes for Evaluating Transaction Events

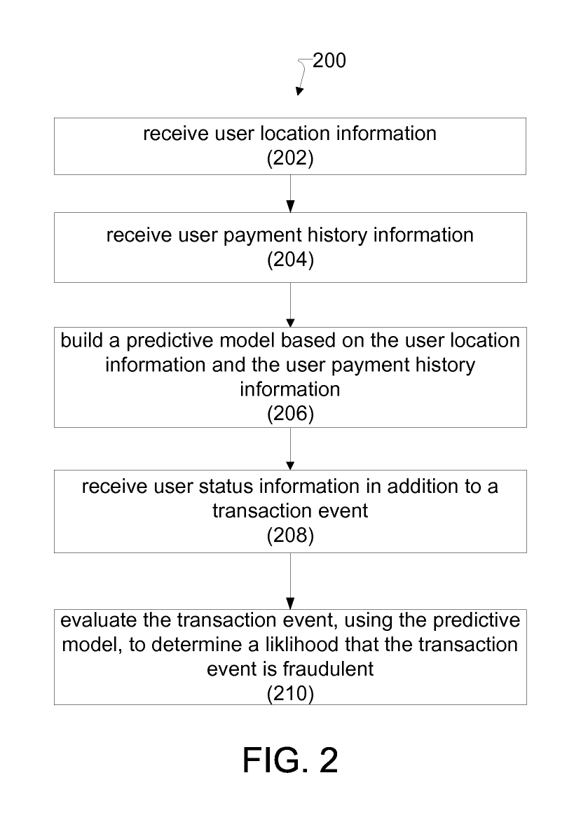

FIG. 2 illustrates an example method 200, for implementing some aspects of the subject technology. Method 200 begins with block 202 in which user location information is received. As discussed above, user location information can include various types of information indicating the location of a user. Furthermore, user location information can include information that may be used to infer the location, or an approximate location of the user. For example, user location information can include time and location information for a purchase made by a user at a physical store or retail establishment.

In certain aspects, user location information may include IP location information (or inferred IP location information) for Internet activity associated with a particular user, e.g., an authenticated user. For example, when the user is authenticated or signed into one or more online services (such as an email account, social networking service, etc.) location information for the user's current and/or past Internet usage may be received as user location information.

In block 204, user payment history information is received. User payment history information can include various types of data related to the user's transaction history. By way of example, payment history information can include information related to products or product categories for items that have been purchased by the user. Payment history information may also include information regarding the frequency of recurring purchases or trends in user purchasing behavior, etc.

In certain aspects, other types of information may be received. For example, (e.g., upon the user's consent and/or after proper notice) user demographic information may be received that includes demographic information for one or more users. By way of example, user demographic information can include various types of demographic information for a user.

Although certain examples provided herein can describe a user's information being stored in memory, the user can delete the user information from memory. In example aspects, the user can adjust appropriate privacy settings to selectively limit the types of user information stored in memory, or select the memory in which the user information is stored (e.g., locally on the user's device as opposed to remotely on a server). In example aspects, the user information does not include and/or share the specific identification of the user (e.g., the user's name) unless otherwise specifically provided or directed by the user.

In block 206, a predictive model is built based on the user location information and the user payment history information received in blocks 202 and 204, described above. In certain implementations, the predictive model will be built and/or updated using machine learning techniques. As such, the predictive model may be continuously altered and/or updated as new or more accurate information becomes available. It is understood that any type of information (in addition to user location information and user payment history information) may be used to build and/or update the predictive model. For example, demographic information may be used to build and/or update the predictive model.

In some implementations, an index search response may also be used to build, tune and/or update the predictive model. As described above, an index search response can comprise an indication as to whether or not sensitive and/or private user information is publicly accessible, for example, via the Internet. By way of example, if a user's credit card information were to become available on a publicly accessible database or website, the index search response can indicate that sensitive or private user information was available on the Internet.

In block 208, user status information is received in addition to a transaction event. User status information can comprise an indication as to a status of the user. By way of example, user status information may be generated as a result of the user logging into one or more online accounts or resources, such as an email account or social networking service. As such, user status information can include any type of information regarding a user's status, including but not limited to indications as to the user's current location and/or activities.

The received transaction event will include information related to one or more monetary transactions of the user. Transaction events may comprise information regarding a recent purchase made by the user, such as credit card purchases. Transaction events may also comprise information related to the movement or transfer of funds by the user, for example, the transfer of funds from one electronic account into another. By way of example, a transaction event may be generated each time a user makes a purchase, or moves funds from one account into another.

In block 210, the transaction event is evaluated using the predictive model to determine a likelihood that the transaction event is fraudulent. The evaluation of a transaction event can be made using various types of information in addition to user location information, user payment history information, user status information and/or an index search response.

The evaluation of the transaction event using the predictive model may result in a quantifiable indication of the likelihood that the transaction event is fraudulent. For example, the result of the evaluation of the transaction event using the predictive model may produce a numeric quantity such an integer or real number value. In certain aspects, the result of the evaluation may include multiple numeric values, such as a vector quantity.

The result of the evaluation of the transaction event can be compared to a threshold for determining the likelihood that the transaction event is fraudulent. In certain aspects, if the result of the evaluation exceeds the threshold, the occurrence of the transaction event will be flagged as potentially fraudulent. Depending on implementation, different actions may be triggered by the detection of a potentially fraudulent transaction event. For example, the detection of a potentially fraudulent transaction event can cause a notification to be sent to the user, e.g., via email, text message or notification delivery to a social networking service.

IV. Example Network Systems for Implementing a Predictive Model

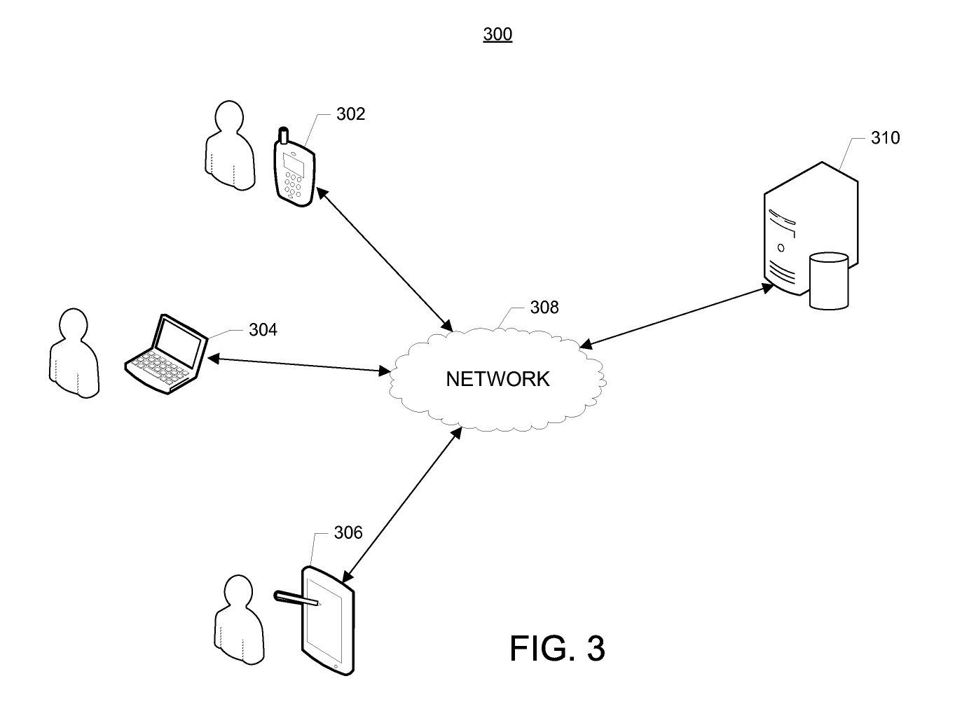

FIG. 3 illustrates an example network system that can be used to implementing some aspects of the subject technology. Specifically, network system 300 comprises user devices 302, 304 and 306, server 310 and network 408. As illustrated, the user devices 302, 304 and 306, are communicatively connected to server 310, via network 308. It is understood that in addition to the user devices 302, 304 and 306 and server 310, any number of other processor-based devices can be communicatively connected to network 308. Furthermore, network 308 can comprise multiple networks, such as a network of networks, e.g., the Internet.

One or more of processes of the subject technology may be carried out by one or more of user devices 302, 304 and 306 and server 310, over network 308. By way of example, server 310 can be configured to perform operations for receiving user location information, receiving user payment history information and building a predictive model for a user, based on the user location information and the user payment history information. User location information and/or user payment history information may be received from one or more sources, such as other servers (not shown) or one or more of user devices 302, 304 and 306. In certain aspects, server 310 may further be configured for receiving user status information in addition to a transaction event and evaluating the transaction event using the user status information and the predictive model to determine a likelihood that the transaction event is fraudulent.

Although certain examples provided herein can describe a user's information being stored in memory, the user can delete the user information from memory and/or choose to prevent future instances of user information from being stored in memory. In example aspects, the user can adjust appropriate privacy settings to selectively limit the types of user information stored in memory, or select the memory in which the user information is stored (e.g., locally on the user's device as opposed to remotely on a server). In example aspects, the user information does not include and/or share the specific identification of the user (e.g., the user's name) unless otherwise specifically provided or directed by the user.

In certain aspects, server 310 (either alone, or in conjunction with one or more processor based systems) may be configured to perform operations for receiving an index search response indicating the availability of user information on a computer network, wherein evaluating the transaction event is also based on the index search response. Furthermore, server 310 can be configured to send a notification to a user if the likelihood that the transaction event is fraudulent exceeds a threshold.

V. Example Systems for Evaluating Transaction Events Using a Predictive

Model

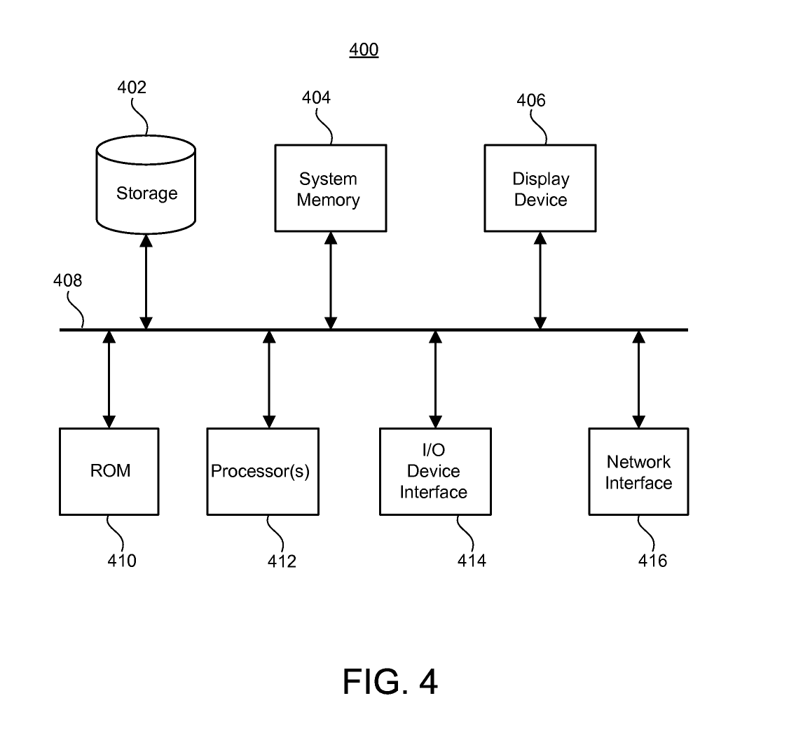

FIG. 4 illustrates an example of an electronic system 400 with which some aspects of the subject technology can be implemented. In some examples, electronic system 400 can be a single computing device such as a server. Furthermore, in some implementations, electronic system 400 can be operated alone or together with one or more other electronic systems e.g., as part of a cluster or a network of computers.

As illustrated, electronic system 400 comprises storage 402, system memory 404, output device interface 406, system bus 408, ROM 410, processor(s) 412, input device interface 414 and network interface 416. In some aspects, system bus 408 collectively represents all system, peripheral, and chipset buses that communicatively connect the numerous internal devices of electronic system 400. For instance, system bus 408 communicatively connects processor(s) 412 with ROM 410, system memory 404, output device interface 406 and permanent storage device 402.

In some implementations, the processor(s) 412 retrieve instructions to execute (and data to process) in order to execute the processes of the subject technology. Processor(s) 412 can be a single processor or a multi-core processor in different implementations. Additionally, processor(s) 412 can comprise one or more graphics processing units (GPUs) and/or one or more decoders, depending on implementation.

ROM 410 stores static data and instructions that are needed by processor(s) 412 and other modules of electronic system 400. Similarly, processor(s) 412 can comprise one or more memory locations such as a CPU cache or processor in memory (PIM), etc. Storage device 402, is a read-and-write memory device. In some aspects, this device can be a non-volatile memory unit that stores instructions and data even when electronic system 400 is without power. Some implementations of the subject disclosure can use a mass-storage device (such as solid state, magnetic or optical storage devices) e.g., permanent storage device 402.

Other implementations can use one or more a removable storage devices (e.g., magnetic or solid state drives) such as permanent storage device 402. Although the system memory can be either volatile or non-volatile, in some examples the system memory 404 is a volatile read-and-write memory, such as a random access memory. System memory 404 can store some of the instructions and data that the processor needs at runtime.

In some implementations, the processes of the subject disclosure are stored in system memory 404, permanent storage device 402, ROM 410 and/or one or more memory locations embedded with processor(s) 412. From these various memory units, processor(s) 412 retrieve instructions to execute and data to process in order to execute the processes of some implementations of the instant disclosure.

Bus 408 also connects to the input device interface 414 and output device interface 406. Input device interface 414 enables a user to communicate information and select commands to electronic system 400. Input devices used with input device interface 414 may include for example, alphanumeric keyboards and pointing devices (also called “cursor control devices”) and/or wireless devices such as wireless keyboards, wireless pointing devices, etc.

Finally, as shown in FIG. 4, bus 408 also communicatively couples electronic system 400 to a network (not shown) through network interface 416. It should be understood that network interface 416 can be either wired, optical or wireless and may comprise one or more antennas and transceivers. In this manner, electronic system 400 can be a part of a network of computers, such as a local area network (“LAN”), a wide area network (“WAN”), or a network of networks, such as the Internet (e.g., the network 308, as discussed above).

Certain aspects of the subject technology can be carried out by electronic system 400. In some aspects, instructions for performing one or more processes of the present disclosure will be stored on one or more memory devices such as the storage 402 and/or the system memory 404.

As such, electronic system 400 can be used for detecting a fraudulent payment transaction. For example, processors 412 can be configured to perform operations including receiving demographic information for a user, receiving user location information,receiving user payment history information and building a predictive model, for a user, based on the demographic inforamation, the user location information and the user payment history information. In certain aspects, processors 412 may be further configured to perform operations for receiving user status information in addition to a transaction event and evaluating the transaction event using the user status information and the predictive model to determine a likelihood that the transaction event is fraudulent.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method to use past location information and current status information to detect fraud, comprising:
receiving, using one or more computing devices, internet protocol geo-location information for a user computing device associated with present or past online activity of a user indicating a plurality of past physical locations of the user;
determining, using the one or more computing devices, the plurality of past physical locations of the user based on the received internet protocol geo-location information for the user computing device;
receiving, using the one or more computing devices, user payment history information for a plurality of past purchases associated with the user;
receiving, using the one or more computing devices, user status information comprising a current location of the user in addition to a recent transaction event;
receiving, using the one or more computing devices, an index search response the availability of user information via one or more publically available online resources;
determining, using the one or more computing devices, a likelihood that the recent transaction event is fraudulent, using the one or more computing devices, the likelihood determined based on the received user status information, the received user payment history information, the received index search response, and the determined plurality of past physical locations of the user determined from the received internet protocol geo-location information for the user computing device;
determining, using the one or more computing devices, that the determined likelihood exceeds a predefined threshold; and
in response to determining that the determined likelihood exceeds the predefined threshold, transmitting, using the one or more computing devices, a notification to the user computing device that the recent transaction event is fraudulent.

2. The method of claim 1, further comprising:
receiving, using the one or more computing devices, an index search response indicating the availability of user information via one or more publically available online resources,
wherein evaluating the recent transaction event is further based on the index search response.

3. The method of claim 2, wherein the index search response comprises an indication of the sensitive or personal information of the user.

4. (canceled)

5. The method of claim 1, wherein the user payment history information comprises one or more valid credit card transactions for the user.

6. The method of claim 1, wherein evaluating the recent transaction event to determine a likelihood that the transaction event is potentially fraudulent is further based on one or more of location information and payment history information, for one or more different users.

7. (canceled)

8. The method of claim 1, wherein user payment history information comprises a credit card transaction history for the user.

9. The method of claim 1, wherein the user status information further comprises online activity information for the user.

10. A system to use past location information and current status information to detect fraud, comprising:
a storage device; and
a processor communicatively coupled to the storage device, wherein the processor executes application code instructions that are stored in the storage device to cause the system to:
receive demographic information for a user;
receive internet protocol geo-location information for a user computing device associated with the user;
determine a plurality of past physical locations of a user based on the received internet protocol geo-location information for the user;
receive user payment history information for a plurality of past purchases associated with the user;
receive user status information comprising a current location in addition to a recent transaction event;
evaluate the recent transaction event using the received user status information, the received user payment history information, and the determined plurality of past physical locations of the user determined from the received internet protocol geo-location information for the user computing device to determine a likelihood that the transaction event is fraudulent; and
send a notification to the user when the likelihood exceeds a predefined value.

11. The system of claim 10, wherein the processor is further configured to execute computer-readable instructions stored in the storage medium to cause the system to receive an index search response indicating the availability of user information via one or more publically available online resources, wherein evaluating the recent transaction event is further based on the index search response.

12. The system of claim 11, wherein the index search response comprises an indication of the public availability of sensitive or personal information of the user.

13. (canceled)

14. The system of claim 10, wherein the user payment history information comprises one or more valid credit card transactions for the user.

15. The system of claim 10, wherein evaluating the recent transaction event to determine a likelihood that the transaction event is potentially fraudulent is further based on one or more of location information and payment history information, for one or more users other than the user.

16. The system of claim 10, wherein the user status information comprises online activity information for the user.

17. A computer program product, comprising:
a non-transitory computer-readable medium having computer-readable program instructions embodied thereon that when executed by a computer cause the computer to use past location information and current status information to detect fraud, the computer-readable program instructions comprising:
computer-readable program instructions to receive demographic information for a user;
computer-readable program instructions to receive internet protocol geo-location information for a user computing device associated with a user;
computer-readable program instructions to determine a plurality of past physical locations of a user based on the received internet protocol geo-location information for the user computing device;
computer-readable program instructions to receive user payment history information for a plurality of past purchases associated with the user;
computer-readable program instructions to receive user status information comprising a current location in addition to a recent transaction event;
computer-readable program instructions to evaluate the recent transaction event using the received user status information, the received user payment history information, and the determined plurality of past physical locations of the user determined from the received internet protocol geo-location information for the user computing device to determine a likelihood that the transaction event is fraudulent; and
computer-readable program instructions to send a notification to the user when the likelihood exceeds a predefined value.

18. The computer program product of claim 17, further comprising computer-readable program instructions to receive an index search response indicating the availability of user information via one or more publically available online resources, wherein evaluating the recent transaction event is further based on the index search response.

19. The computer program product of claim 18, wherein the index search response comprises an indication of the public availability of sensitive or personal information of the user.

20. The computer program product of claim 17, wherein evaluating the recent transaction event to determine a likelihood that the transaction event is potentially fraudulent is further based on one or more of location information and payment history information, for one or more different users.
